(19) United States
(12) Patent Application Publication
(10) Pub. No.: US 2017/0167135 A1
(43) Pub. Date: Jun. 15, 2017

(54) Internal Arch Diaphragm

(71) Applicant: David Charles Nowakowski, Erie, PA (US)

(72) Inventor: David Charles Nowakowski, Erie, PA (US)

(21) Appl. No.: 14/757,287

(22) Filed: Dec. 14, 2015

(51) Int. Cl. E04B 5/43; E04B 5/16

(52) U.S. Cl. CPC E04B 5/43; E04B 5/16; B60B 17/0006

(57) ABSTRACT

Cantilevers are a common occurrence in the field of mechanics. Typically, the analysis of cantilevers involves the use of a uni-axial system common to the analysis of a cross section undergoing flexural deformation. The internal arch diaphragm utilizes a biaxial system of forces to redirect flexural forces that ordinarily cause a cantilever span to fail, into a tension force that can be controlled via reinforcing or other stress control technique such as quenching depending on the material used.

The resulting system is lighter, stronger, and more capable of achieving system benchmarks unreachable without this technique. Further the elimination or rearrangement of support conditions in non cantilevered systems to accommodate the internal arch diaphragm allows for new mechanical systems.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR COMPUTER PROGRAM LISTING COMPACT DISK APPENDIX

Not Applicable

### BACKGROUND OF INVENTION

Diaphragm mechanics are typically classified within the realm of plate mechanics. Fixeties at the extents and interior regions of a diaphragm lead to the development of and control of mechanical forces such as shear and bending moments, however the development of mode shapes and localized deformations lead of instabilities that limit the projection of diaphragms from restraints and supports.

In an effort to more fully utilize the strength and stiffness offered by support conditions a diaphragm can be given restraints within its internal volume that lead to the extension of diaphragm span lengths beyond those typical in modern mechanics. As a result material can be removed from the cross section and a more efficient member or series of members can be created.

Similar diaphragm based systems have been developed in the past including the locomotive wheel, which relies heavily on material redundancy for the management of internal stress. The foldable paper fan often seen in not specific Asian motifs utilizes a similar arrangement but utilizes flexure of each fold rather than force transfer between folds for rigidity.

### BRIEF SUMMARY OF INVENTION

The invention can be used to distribute stress in large disks such as floor slabs and steel disks such as locomotive wheels and automotive disk brakes. In the case of a concrete floor the invention utilizes pre-stressing cables or more precisely tendons similar to cable stayed bridge systems, although the cable is rotated from a position above the deck, as is common in cable stay bridges and is instead placed within the slab or below the slab. Further the sectors that divide the slab are lined with a steel plate or concrete ridge that regulates the contact area between adjacent sectors. In effect this system is a cable stayed bridge that have been rotated 180 degrees around a support tower in order to create a diaphragm rather than a linear span.

Once the slab sectors, contact plates, and pinned connections are in place the pre-stress/cable stay cable can be used to apply axial force to each sector. As the cable is oriented to apply an axial load and a vertical load the sectors a closed in on each other to form a solid plate. Reinforcing steel within each concrete sector is used, as is common in the current state of the art within the construction industry, to provide structural rigidity within the concrete sectors.

A cantilevered condition is created from an interior support once shoring is removed from beneath the concrete slab and the concrete self weight and the cable stay/pre-stress load restrain each sector against its neighbor sector. Force is transferred across the steel plate lining the boundary of each sector and is then directed into the pre-stress/cable stay cable. The span limit for this cantilever slab condition is based on the compressive stress of the concrete and the tensile stress of the cable stay/pre-stress cable.

A similar case can be built within the steel disk of a locomotive wheel, and it is likely that the current shape of locomotive wheels unwittingly take advantage of the supporting phenomena, that is presented here. By creating bored or cast tubes within the disk of the wheel, which mimic the pre-stress cable in the slab above, the interior surface of the tubes can be quenched, stressing the wheel radial. This stress redirection can allow for the removal of material from the outside surface of the wheel and the creation of a more efficient section.

### BRIEF DESCRIPTION OF THE SEVERAL VIEWS OF THE DRAWING

FIG. 1—Plan View of Diaphragm

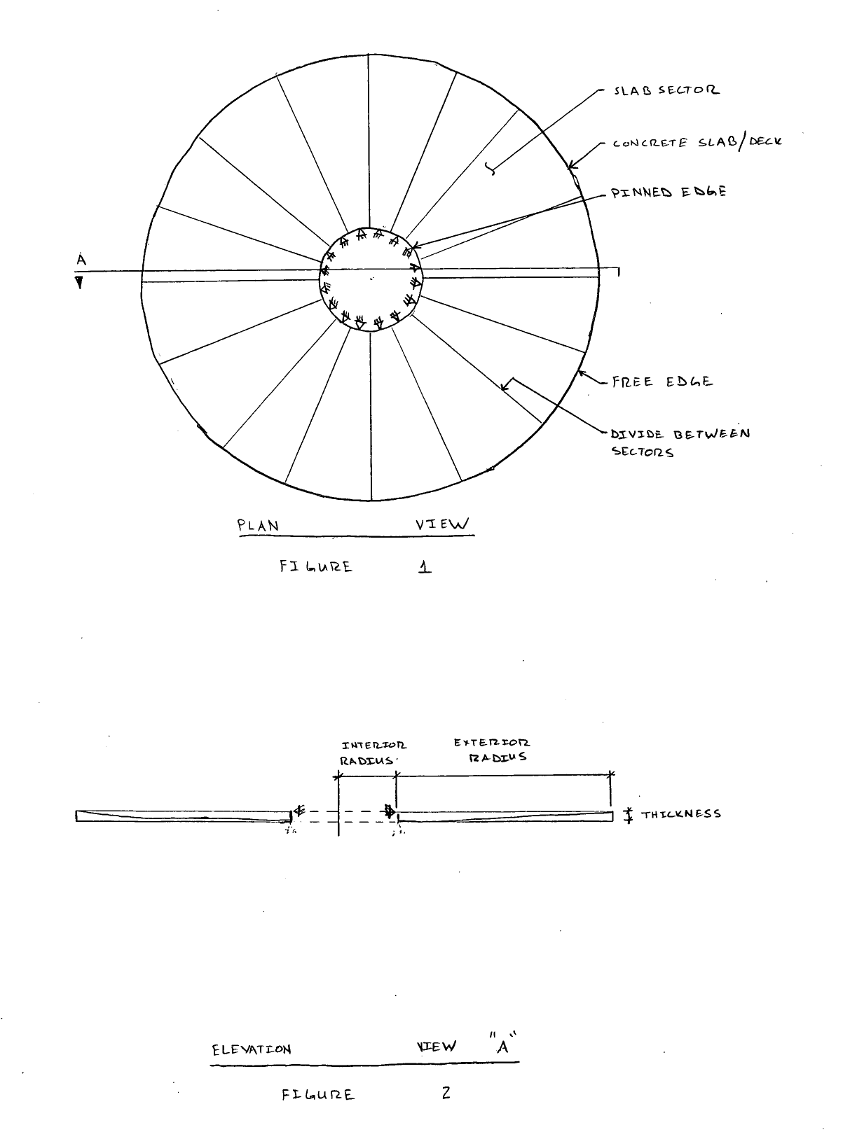

FIG. 2—Elevation View of Diaphragm at Diameter

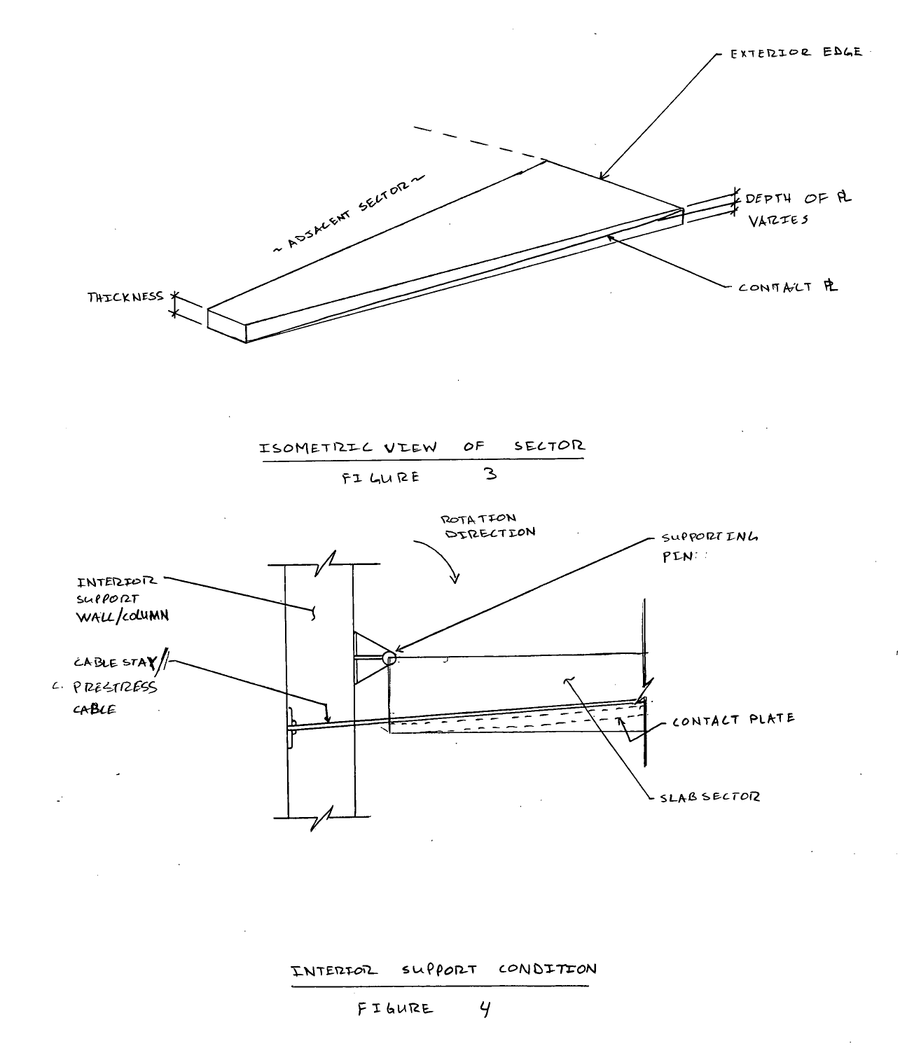

FIG. 3—Isometric View of Sector

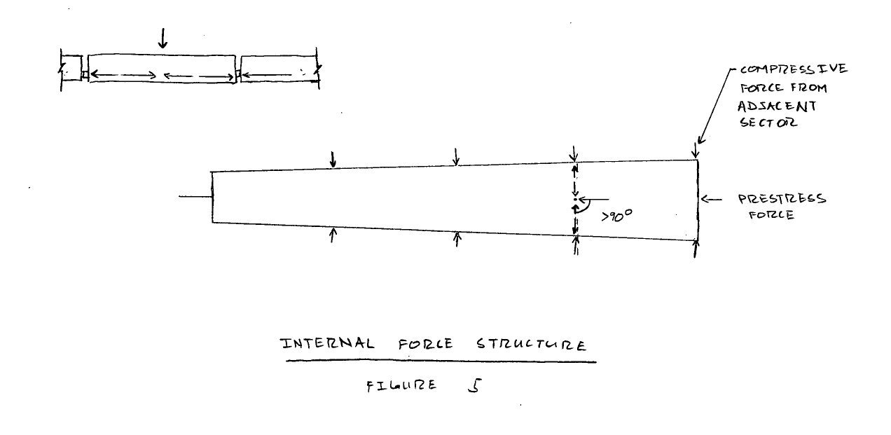

FIG. 4—Interior Support Condition Detail

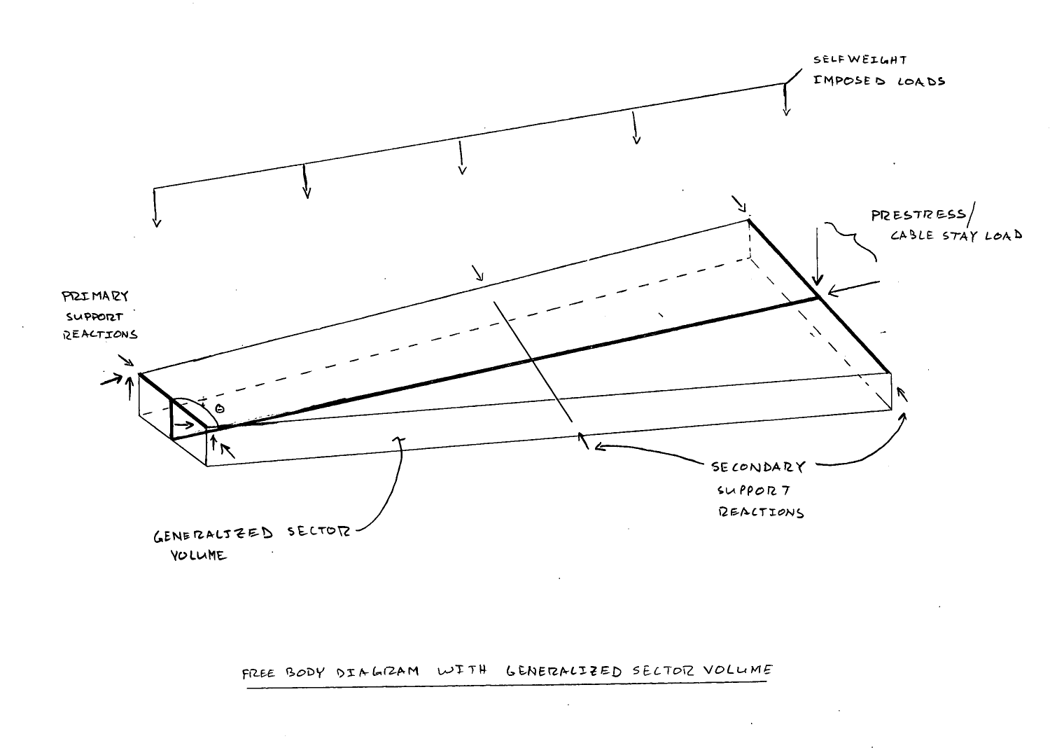

FIG. 5—Internal Force Structure

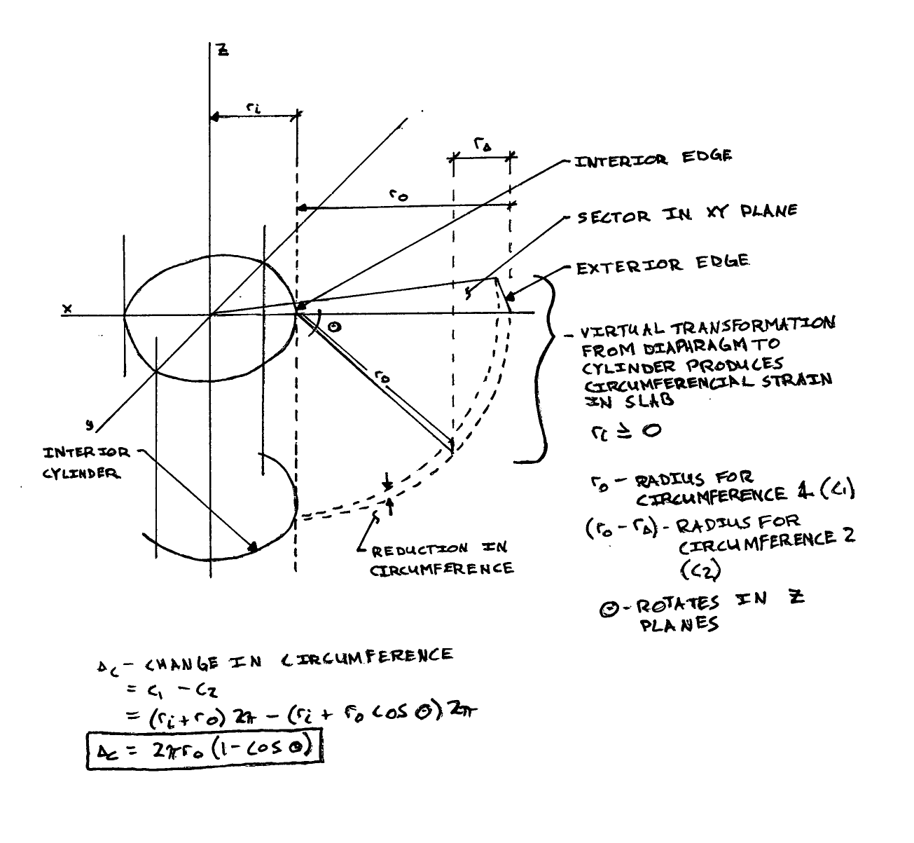

FIG. FBD—Free Body Diaphragm with Generalized Sector Volume

### DETAILED DESCRIPTION OF THE INVENTION

The defining feature of the internal arch diaphragm, is the interior support condition. A pinned connection at the top, interior end, of each sector forces each sector to rotate downward around the support. This rotation forces each sector to be compressed against its neighboring sector. This compression arises as the trapezoidal sectors are virtually deformed into rectangular shapes. In other words the act of transforming a disk into a cylinder, about the interior ring of the disk, provides the ability to regulate the stresses that this transformation creates in the solid structure.

The contact surface between each sector can be places anywhere within the thickness and length of the surface joining adjacent sectors. This plate, likely 2 or 3 inches deep, approximately ¼ to ½ inches thick, and likely the entire length of the adjoining sectors, regulates contact between sectors. At interior locations the plate is placed near the bottom of the slab to facilitate force transfer between each sector. In order to alleviate this transfer the plate gradually rises toward the top of the slab as its length approaches the periphery of the slab.

Regulation of the plate depth and thickness allows an internal strut and tie structure to be created within the volume of each sector. The struts direct force toward the pre-stress cable for the resolution of the tensile force, which if left unrestrained pulls each sector apart, perpendicular to its length.

A similar case structure can be built within the steel disk of a locomotive wheel, and it is likely that the current shape of locomotive wheels unwittingly take advantage of the supporting phenomena, that is presented above. By creating bored or cast tubes within the disk of the wheel, which mimic the pre-stress cable in the slab above, the interior surface of the tubes can be quenched, stressing the wheel radialy. This stress redirection can allow for the removal of material from the outside surface of the wheel.

It should be noted that the interior support, in the simplest case, is placed at the center of rotation for each sector, but in more complicated systems the center of rotation could be a point or points away from the sector supports. The top of the sector corresponds with the radius of that rotation and the contact plate is kept below this boundary. If the contact plate is placed above this line the rotation would cause a decrease in compression at each contact point placed above the boundary. This may be beneficial in more complicated systems.

This system differs from current diaphragm technology such as pre-stressed concrete floor panels and post tensioned concrete decking. Current diaphragm systems transfer force into tensioned reinforcing through flexural deformation. Further cantilevered sections do not utilize adjacent members for support.

1. (canceled)

2. (canceled)

3. (canceled)

4. (canceled)

5. (canceled)

6. (canceled)

7. A series of structural beams, composed of building materials, comprising a centrally supported cantilevered diaphragm for use in construction, typically as a floor or roof diaphragm with a central support but no external supports or in fabrication typically as a wheel hub, comprising of beams with a prismatic but varying cross section, which rest against one and other along the length wise edge of each beam, and in their plurality comprise the diaphragm.

8. Each beam of claim 1 with an angled prestress strut or external force that can provide similar confining forces, the prestressed strut attached to the cantilevered end of the beam and to the support, rather than to the beam end, at the opposite end. The prestress strut used to reduce tension along the length of the beam, while the angle of the strut provides a force mainly at the free end of the beam but also along its length normal to the length of the beam to force adjacent beams together along their length. The angle of the prestress tendon, orchestrated to force rotation of the beam about the supported end and as a result force adjacent beams together. The supported end of the beam is not connected to the prestressed strut. The strut passes through the end of the beam to an alternative anchor point.

9. The beam of claim 1, being forced together with adjacent beams along its length, having a boundary with each adjacent beam that varies in depth and, location within the depth of the beam, relative to the beam cross section, and along the length of the beam. The over all shape and location along the length of the beam, of the contact surface between beams, being of primary importance in controlling the forces that arise, due to circumferential strain.

10. The beam of claim 1, having an arrangement of attachments at the non free end of the beam to the support structure at or near the center of the diaphragm, which is free to rotate in the direction perpendicular to the plane of the diaphragm, but can offer stiffness at the attachment to the support against rotation about the long axis of the beam, thereby providing resistance to torsion from the beam at the attachment to the support. The attachment to the support offering free rotation for the beam perpendicular to the plane of the diaphragm and collinear with the length of the beam, but offering a reaction against shear force at the attached end of the beam in three coordinate directions. The attachment location being placed at a point within the depth of the beam end, that corresponds to the over all shape of the contact surface between beams for the regulation of circumferential strain.

11. The support of the diaphragm being perpendicular to the plane of the diaphragm, being of a column like form or of a form with more than on column, but centrally located for support of the diaphragm.

12. The rotation of the beam in claim 1, about its supported end, providing the boundary conditions for the transfer of stress between adjacent beams, and into the support.
